(19) United States
(12) Patent Application Publication
(10) Pub. No.: US 2020/0317228 A1
(43) Pub. Date: Oct. 8, 2020

(54) VEHICLE CONTROL SYSTEM

(71) Applicant: TOYOTA JIDOSHA KABUSHIKI KAISHA, Toyota-shi (JP)

(72) Inventor: Hirotada OTAKE, Susono-shi (JP)

(73) Assignee: TOYOTA JIDOSHA KABUSHIKI KAISHA, Toyota-shi (JP)

(21) Appl. No.: 16/809,174

(22) Filed: Mar. 4, 2020

(30) Foreign Application Priority Data
Apr. 4, 2019 (JP) 2019-072236

(51) Int. Cl. B60W 60/00; B60W 50/14

(52) U.S. Cl. CPC B60W 60/0059; B60W 50/14; B60W 2520/10; G05D 1/0061; B60W 2552/40; B60W 2540/00; B60W 2555/20

(57) ABSTRACT

A control device includes a status recognition unit, an autonomous driving controller, an alert controller, and a requested level setting unit. The status recognition unit recognizes a status of a driver. The autonomous driving controller executes autonomous driving control. The alert controller executes an alert control. The requested level setting unit sets a requested level. The autonomous driving controller prohibits the execution of the autonomous driving control in a case where the requested level is equal to or higher than an actual level. The requested level setting unit sets the requested level in each of at least two divided vehicle speed ranges. The requested level set in a relatively low vehicle speed range is lower than the requested level set in a relatively high vehicle speed range.

### INCORPORATION BY REFERENCE

The disclosure of Japanese Patent Application No. 2019-072236 filed on Apr. 4, 2019 including the specification, drawings and abstract is incorporated herein by reference in its entirety.

### BACKGROUND

### 1. Technical Field

The present disclosure relates to a vehicle control system that executes autonomous driving control of a vehicle.

### 2. Description of Related Art

Japanese Unexamined Patent Application Publication No. 2018-088060 (JP 2018-088060 A) discloses an autonomous driving device. The autonomous driving device executes two kinds of autonomous driving control. First autonomous driving control is driving assistance control including traveling control and steering control of a vehicle. Second semi-autonomous driving control is driving assistance control in which one of traveling control and steering control is executed and the execution of the other control is stopped.

The autonomous driving device determines establishment of a start condition for the execution of the first autonomous driving control during the execution of the second semi-autonomous driving control. In a case where the start condition is satisfied, the execution of traveling control or the steering control during the stop is restarted. As the start condition, a traveling zone of the vehicle, elimination of a factor for override to the traveling control or the steering control, and coincidence of an operation amount of a traveling device of a driver and an operation amount of a control device are exemplified.

### SUMMARY

From a viewpoint of securing traveling safety, it is desirable that the driver of the vehicle is continuously involved in driving of the vehicle at a given level or more even during the execution of the autonomous driving control. However, from a viewpoint of expanding convenience for the driver, it is not desirable that the level of involvement is fixed to the given level under all circumstances during the execution of the autonomous driving control.

The present disclosure provides a technique for achieving both of expansion of convenience for a driver and securing of traveling safety during execution of autonomous driving control.

A first aspect of the present disclosure relates to a vehicle control system. The vehicle control system includes a status detection device, a vehicle speed detection device, and a control device. The status detection device is configured to detect a status of a driver of a vehicle. The vehicle speed detection device is configured to detect a traveling speed of the vehicle. The control device is configured to execute autonomous driving control of the vehicle. The control device is configured to acquire an actual level indicating an actual level of involvement of the driver in driving of the vehicle based on the status of the driver, set a requested level indicating a level of involvement in the driving of the vehicle requested to the driver by the control device based on the traveling speed, and prohibit the execution of the autonomous driving control in a case where the requested level is equal to or higher than the actual level. The requested level is set in each of at least two divided vehicle speed ranges. The requested level set in a relatively low vehicle speed range is lower than the requested level set in a relatively high vehicle speed range.

A second aspect of the present disclosure further has the following features according to the first aspect. The vehicle control system may further include an information providing device. The information providing device may be configured to provide information to the driver. The control device may be configured to output a control signal for prompting to involve in the driving of the vehicle to the information providing device in a case where the requested level is equal to or higher than the actual level.

A third aspect of the present disclosure further has the following features according to the first or second aspect. The control device may be configured to acquire environment information around the vehicle or recognition status information of a recognition system sensor of the vehicle, and change boundary values of the at least two divided vehicle speed ranges based on the environment information or the recognition status information.

A fourth aspect of the present disclosure further has the following features according to the third aspect. The environment information may be information regarding an amount of rainfall around the vehicle. The control device may be configured to decrease the boundary values in a case where the amount of rainfall is large than in a case where the amount of rainfall is small.

A fifth aspect of the present disclosure further has the following features according to the third aspect. The environment information may be information regarding weather around the vehicle. The control device may be configured to decrease the boundary values in a case where the weather is cloudy than in a case where the weather is fine, and decrease the boundary values in a case where the weather is rainy than in a case where the weather is cloudy.

A sixth aspect of the present disclosure further has the following features according to the third aspect. The environment information may be information regarding a frictional coefficient of a road surface on which the vehicle travels. The control device may be configured to decrease the boundary values in a case where the frictional coefficient is small than in a case where the frictional coefficient is large.

A seventh aspect of the present disclosure further has the following features according to the third aspect. The recognition status information may be an upper limit value of a distance at which the recognition system sensor is able to recognize an object around the vehicle. The control device may be configured to decrease the boundary values in a case where the upper limit value is small than in a case where the upper limit value is large.

An eighth aspect of the present disclosure further has the following features according to the third aspect. The vehicle control system may further include a map database storing map information. The recognition status information may be an error between a feature of an object around the vehicle recognized by the recognition system sensor and a feature of the object included in the map information. The control device may be configured to decrease the boundary values in a case where the error is large than in a case where the error is small.

According to the first aspect, the requested level that is used as a determination threshold value about whether or not to prohibit the execution of the autonomous driving control is set in each of the at least two divided vehicle speed ranges. In addition, the requested level of the relatively low vehicle speed range is set to a level lower than the requested level of the relatively high vehicle speed range. Here, in a case where the vehicle travels at a low speed, it is easier to secure traveling safety than in a case where the vehicle travels at a high speed. For this reason, in a case where the requested level is set as described above, it is possible to expand convenience in a case where the vehicle is traveling at a low speed, and to reliably secure traveling safety in a case where the vehicle is traveling at a high speed. Accordingly, it is possible to achieve both expansion of convenience and securing of traveling safety during the execution of the autonomous driving control.

According to the second aspect, the control signal for prompting to involve in the driving of the vehicle is output to the information providing device in a case where the requested level is equal to or higher than the actual level. Accordingly, it is possible to prompt the driver to involve in the driving of the vehicle. Therefore, it is possible to increase an opportunity for the execution of the autonomous driving control. Furthermore, it is possible to avoid interruption of the autonomous driving control in execution.

According to the third to eighth aspects, the boundary values of the at least two divided vehicle speed ranges are changed based on the environment information or the recognition status information. Accordingly, it is possible to execute determination processing about whether or not to prohibit the execution of the autonomous driving control using the determination threshold value set in consideration of the environment information or the recognition status information.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a block diagram showing a configuration example of a vehicle control system according to Embodiment 1;

FIG. 2 is a block diagram showing a configuration example of functions of a control device shown in FIG. 1;

FIG. 3 is a diagram illustrating a setting example of a requested level;

FIG. 4 is a diagram illustrating another setting example of a requested level;

FIG. 5 is a flowchart illustrating a flow of determination processing of an execution condition of autonomous driving control;

FIG. 6 is a flowchart illustrating a flow of processing of alert control;

FIG. 7 is a block diagram showing a configuration example of functions of a control device of Embodiment 2;

FIG. 8 is a diagram illustrating a first change example of a boundary value;

FIG. 9 is a diagram illustrating a second change example of the boundary value;

FIG. 10 is a diagram illustrating a third change example of the boundary value;

FIG. 11 is a diagram illustrating a fourth change example of the boundary value; and

FIG. 12 is a diagram illustrating a fifth change example of the boundary value.

### DETAILED DESCRIPTION OF EMBODIMENTS

Hereinafter, embodiments will be described referring to the drawings. It is to be understood that, in a case where number, such as the number of pieces of each element, numerical quantity, amount, and range, are mentioned in the following embodiments, an applicable embodiment of the present disclosure is not limited to the numbers mentioned, except for a case where the numbers are particularly clearly specified or apparently specified in principle. The structure, steps, and the like described in the following embodiments are not necessarily essential to the present disclosure, except for a case where the structure, steps, and the like are particularly clearly specified or apparently specified in principle.

### 1. Embodiment 1

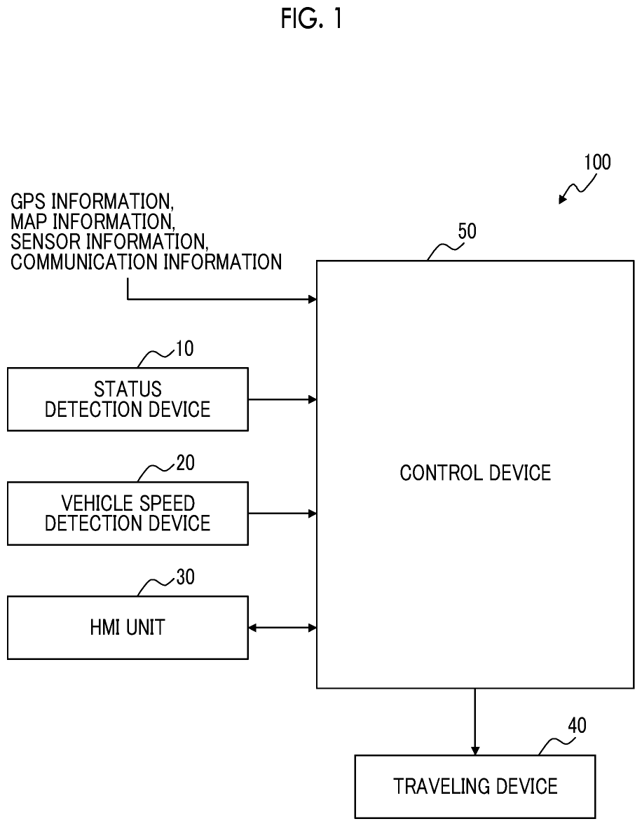

First, Embodiment 1 will be described referring to FIGS. 1 to 6.

1.1 Overall Configuration of Vehicle Control System

FIG. 1 is a block diagram showing a configuration example of a vehicle control system according to Embodiment 1. A vehicle control system 100 shown in FIG. 1 is mounted in a vehicle. As the vehicle, a vehicle that has an engine as a power source, an electric vehicle that has a motor as a power source, and a hybrid vehicle that has an engine and a motor are exemplified. The motor is driven by a battery, such as a secondary battery, a hydrogen fuel cell, a metal fuel cell, or an alcohol fuel cell.

The vehicle control system 100 is a system that executes autonomous driving control of the vehicle. The autonomous driving control refers to vehicle control for performing a part or all of driving operations (that is, acceleration, braking, and steering) to be performed by a driver of the vehicle instead of the driver. The autonomous driving control is also referred to as driving assistance control. In the autonomous driving control, drive control, braking control, and steering control are included. The drive control and the braking control are collectively referred to as traveling control. The vehicle control system 100 includes a status detection device 10, a vehicle speed detection device 20, a human machine interface (HMI) unit 30, a traveling device 40, and a control device 50.

Though not shown, the vehicle control system 100 further includes various kinds of equipment that acquire information needed for execution of the autonomous driving control. As “needed information”, global positioning system (GPS) information, map information, sensor information, and communication information are exemplified.

The GPS information is information indicating a current position of the vehicle. The map information is information that is stored in a map database. In the sensor information, information from external sensors (for example, a recognition system sensor including a camera and a radar) and internal sensors (for example, an acceleration sensor, a yaw rate sensor, a steering torque sensor, an accelerator pedal sensor, and a brake pedal sensor) is included. The communication information is information that is provided from an information providing system.

The status detection device 10 detects a status of the driver. The status of the driver is included in the above-described “needed information”. As the status detection device 10, a driver monitor camera and a steering wheel touch sensor are exemplified. The driver monitor camera images the face of the driver. In order to image the face of the driver from at least two directions, at least two driver monitor cameras may be provided. The steering wheel touch sensor detects contact of the driver on a steering wheel and pressure when the driver holds the steering wheel. The status detection device 10 transmits imaging information or detection information to the control device 50.

The vehicle speed detection device 20 detects a traveling speed (vehicle speed V) of the vehicle. The traveling speed is included in the above-described “needed information”. The vehicle speed detection device 20 transmits detection information to the control device 50.

The HMI unit 30 exchanges various kinds of information with the driver. The HMI unit 30 includes a display device, an input device (for example, operation buttons and a touch panel), a voice output device, and a voice input device. The HMI unit 30 transmits information input from the driver to the control device 50. The HMI unit 30 provides information to the driver based on a control signal from the control device 50. In information that is provided to the driver, traveling circumstances of the vehicle and a predetermined alert are included. In a case of providing information to the driver, the HMI unit 30 functions as an information providing device of the present disclosure.

The traveling device 40 makes the vehicle autonomously travel according to the control signal from the control device 50. The traveling device 40 includes a traveling drive power output device, a steering device, and a brake device. The traveling drive power output device generates traveling drive power. The steering device turns wheels. The brake device generates braking force that is provided to the wheels.

The control device 50 is a microcomputer including a processor, a memory, and an input/output interface. The control device 50 receives various kinds of information through the input/output interface. Then, the control device 50 executes the autonomous driving control based on the received information. Hereinafter, the configuration of the control device 50 will be described.

1.2 Configuration of Control Device

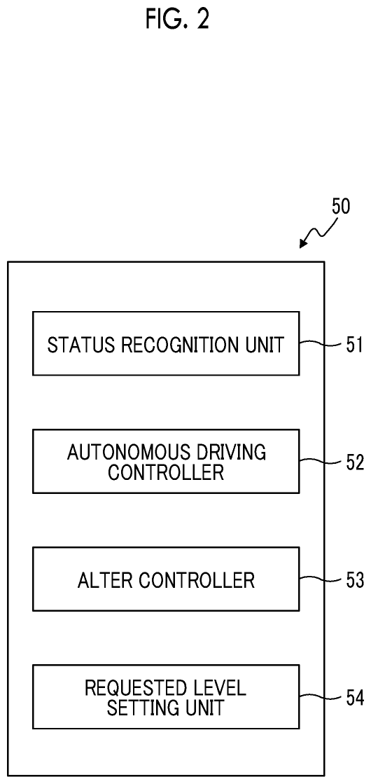

FIG. 2 is a block diagram showing a configuration example of functions related to the autonomous driving control of the control device 50. As shown in FIG. 2, the control device 50 includes a status recognition unit 51, an autonomous driving controller 52, an alert controller 53, and a requested level setting unit 54. The functional blocks are implemented by the processor of the control device 50 executing various control programs stored in the memory.

The status recognition unit 51 recognizes the status of the driver based on information from the status detection device 10. In the status of the driver, a holding status of the steering wheel (for example, hold, contact, and non-contact) and a sight status (for example, normal sight, lost sight, and closed sight) are included. The status recognition unit 51 recognizes a status of the vehicle based on the above-described “needed information”. In the status of the vehicle, the current position of the vehicle, a traveling environment (for example, a relative position and a relative speed of an object around the vehicle) of the vehicle, and a traveling status (for example, a traveling speed, an acceleration, and a yaw rate) of the vehicle are included. The status recognition unit 51 transmits recognition information to the autonomous driving controller 52, the alert controller 53, and the requested level setting unit 54.

The autonomous driving controller 52 executes the autonomous driving control. In the execution of the autonomous driving control, the autonomous driving controller 52 determines whether or not an execution condition for the autonomous driving control is satisfied based on information from the status recognition unit 51. In the execution condition, a vehicle condition that is satisfied according to the status of the vehicle and a driver condition that is satisfied according to the status of the driver are included. Here, the vehicle condition and the driver condition will be described.

Determination processing of the conditions will be described in detail in Section “1.3”.

As the vehicle condition, the following conditions V1 to V6 are exemplified.

V1: the vehicle is positioned in an area where the autonomous driving control is executable

V2: the vehicle speed V is lower than a threshold value V_{THL}

V3: a steering angle is less than a threshold value

V4: variation (for example, an acceleration, a deceleration, a roll rate, a pitch rate, and a yaw rate) of vehicle movement is less than a threshold value

V5: a recognition status of an external sensor is normal

V6: a door and a window of the vehicle are closed

As the driver condition, the following condition D1 is exemplified.

D1: an actual level DL is equal to or higher than a requested level RL

Here, the “actual level DL” is defined as an actual level of involvement of the driver in driving of the vehicle. The actual level is acquired based on the status of the driver. The “requested level RL” is defined as a level of involvement in the driving of the vehicle requested to the driver by the control device 50. The requested level RL will be described in detail in description of the requested level setting unit 54.

In a case where the vehicle condition and the driver condition are satisfied, the autonomous driving controller 52 sets a target route and generates a traveling plan. The target route is a route along which the vehicle travels with the execution of the autonomous driving control. The traveling plan is generated based on the target route, the map information, the traveling environment of the vehicle, and the traveling status of the vehicle. In the traveling plan, a control target value of the traveling device 40 according to a position on the target route is included. The position on the target route means a vertical position set at each predetermined interval (for example, 1 m) in an extension direction of the target route. The control target value is set in association with the vertical position on the target route. In the control target value, a target horizontal position and a target vehicle speed are included. The autonomous driving controller 52 transmits a control signal indicating the control target value to the traveling device 40.

The alert controller 53 executes alert control based on information from the status recognition unit 51. In the execution of the alert control, the alert controller 53 determines whether or not an alert condition is satisfied. In a case where the alert condition is satisfied, the alert controller 53 transmits a control signal to the HMI unit 30.

The alert condition and the control signal to be transmitted are set in advance in association with the content of an alert. The alert condition may be set corresponding to the vehicle condition or the driver condition. As such a condition, the following conditions C1 to C3 are exemplified.

C1: a door and a window of the vehicle are opened

C2: the recognition status of the external sensor is not normal

C3: the actual level DL is lower than the requested level RL

A specific processing example of the alert control will be described in detail in Section “1.4”.

The requested level setting unit 54 sets the requested level RL. The requested level RL is set based on a combination of the holding status of the steering wheel and the sight status. Note that, in a case where solely the steering control is executed (that is, in a case where the traveling control is not executed), the requested level RL may be set based on solely the holding status.

Here, “Hands-on” and “Hands-off” are defined as an expression directly representing the holding status. “Hands-on” is defined as a status in which the driver puts the hands on the steering wheel during traveling of the vehicle. “Hands-off” is defined as a status in which the driver takes the hands off the steering wheel during traveling of the vehicle. “Hands-on” is higher than Hands-off” in terms of the level of involvement of the driver in the driving of the vehicle.

“Eyes-on” and “Eyes-off” are defined as an expression directly representing the sight status. “Eyes-on” is defined as a status in which the driver is monitoring the periphery during traveling of the vehicle. “Eyes-off” is defined as a status in which the driver is not monitoring the periphery during traveling of the vehicle. “Eyes-on” is higher than “Eyes-off” in terms of the level of involvement of the driver in the driving of the vehicle.

### (1) Setting Example of Requested Level

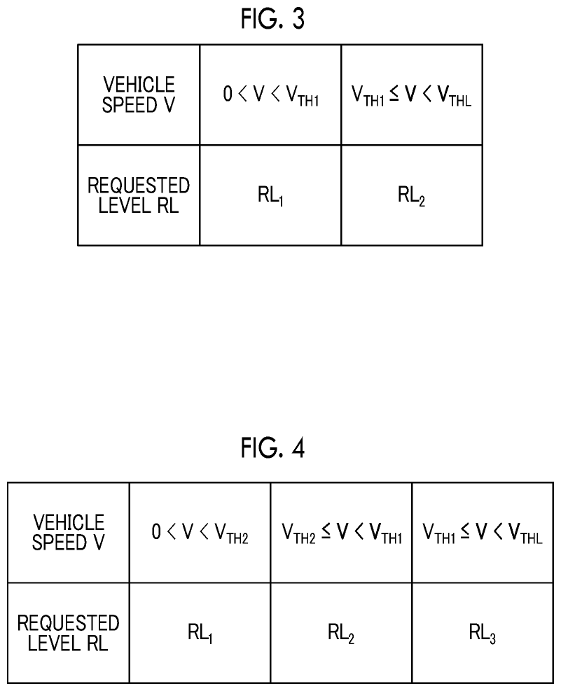

FIG. 3 is a diagram illustrating a setting example of the requested level RL. In the example of FIG. 3, the requested level RL is set in two stages corresponding to divided ranges of the vehicle speed V. Specifically, in a case where the vehicle speed V is in a low speed range 0 to V_{TH1}, the requested level RL is set to a first level RL₁. In a case where the vehicle speed V is in a high speed range V_{TH1} to V_{THL}, the requested level RL is set to a second level RL₂. The boundary value V_{TH1} of the ranges is a traveling speed satisfying 0<V_{TH1}<V_{THL}.

In the example of FIG. 3, the first level RL₁ is a level focused on expansion of convenience for the driver. The second level RL₂ is a level focused on securing of traveling safety. The first level RL₁ is lower than the second level RL₂ in terms of the requested level RL. The levels RL₁, RL₂ are set, for example, as follows.

### (1.1) First Example

first level RL₁: “Hands-off” and “Eyes-off”

second level RL₂: “Hands-off” and “Eyes-on”

### (1.2) Second Example

first level RL₁: “Hands-off” and “Eyes-on”

second level RL₂: “Hands-on” and “Eyes-on”

### (1.3) Third Example (an Example of a Case where Solely the Steering Control is Executed)

first level RL₁: “Hands-off”

second level RL₂: “Hands-on”

### (2) Another Setting Example of Requested Level

FIG. 4 is a diagram illustrating another setting example of the requested level RL. In the example of FIG. 4, the requested level RL is set in three stages corresponding to divided ranges of the vehicle speed V. Specifically, in a case where the vehicle speed V is in a low speed range 0 to V_{TH2}, the requested level RL is set to a first level RL₁. In a case where the vehicle speed V is an intermediate speed range V_{TH2} to V_{TH1}, the requested level RL is set to a second level RL₂. In a case where the vehicle speed V is in a high speed range V_{TH1} to V_{THL}, the requested level RL is set to a third level RL₃. The boundary value V_{TH2} of the ranges is a traveling speed satisfying 0<V_{TH2}<V_{TH1}.

In the example of FIG. 4, the first level RL₁ is a level focused on expansion of convenience. The second level RL₂ is a level focused on the balance of expansion of convenience and securing of traveling safety. The third level RL₃ is a level focused on securing of traveling safety. The levels RL₁, RL₂, RL₃ are set, for example, as follows.

### (2.1) First Example

first level RL₁: “Hands-off” and “Eyes-off”

second level RL₂: “Hands-on” (a status equal to or more than contact and less than hold) and “Eyes-on”

third level RL₃: “Hands-on” (a status equal to or more than hold) and “Eyes-on”

### (2.2) Second Example (an Example of a Case where Solely the Steering Control is Executed)

first level RL₁: “Hands-off”

second level RL₂: “Hands-on” (a status equal to or more than contact and less than hold)

third level RL₃: “Hands-on” (a status equal to or more than hold)

In the above-described example (2), “Hands-on” in the above-described example (1) is divided into “Hands-on” (a status equal to or more than contact and less than hold) and “Hands-on” (a status equal to or more than hold). “Hands-on”(a status equal to or more than hold) is higher than “Hands-on” (a status equal to or more than contact and less than hold) in terms of the level of involvement of the driver in the driving of the vehicle. That is, the second level RL₂ is lower than the third level RL₃ in terms of the requested level RL.

1.3 Determination Processing of Execution Condition

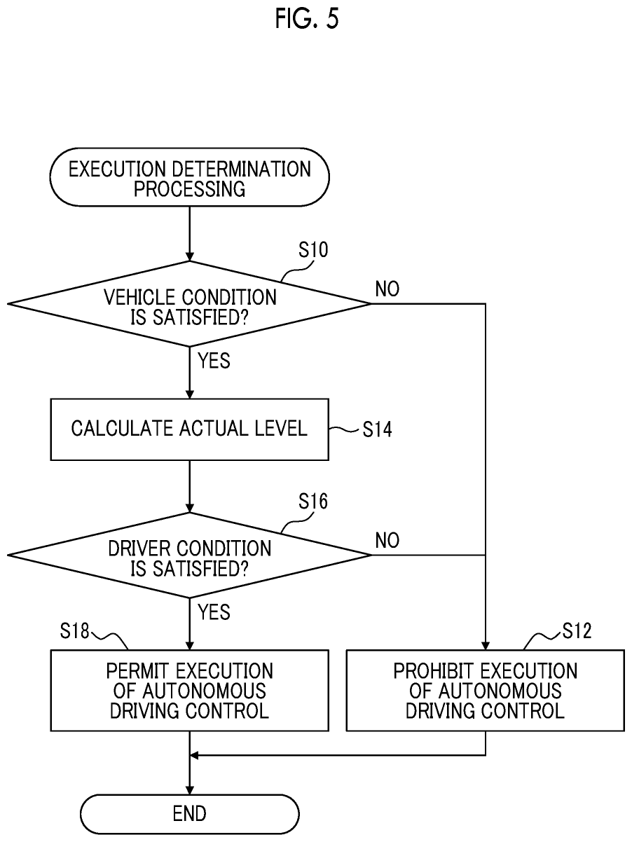

FIG. 5 is a flowchart illustrating a flow of determination processing of the execution condition that is executed by the autonomous driving controller 52. A processing routine shown in FIG. 5 is repeatedly executed during traveling of the vehicle.

In the processing routine shown in FIG. 5, first, determination is made whether or not the vehicle condition is satisfied (Step S10). The processing of Step S10 is executed based on the status of the vehicle included in the recognition information from the status recognition unit 51. In a case where a determination result of Step S10 is negative, the execution of the autonomous driving control is prohibited (Step S12). “The execution of the autonomous driving control is prohibited” means that processing for prohibiting the execution of the autonomous driving control or processing for interrupting the autonomous driving control in execution.

In a case where the determination result of Step S10 is affirmative, the actual level DL is acquired (Step S14). The actual level DL is acquired based on the status (that is, the holding status and the sight status) of the driver included in the recognition information from the status recognition unit 51. The actual level DL to be acquired is, for example, as follows.

### (1) First Example

holding status: a status equal to or more than hold

sight status: a periphery monitoring status

### (2) Second Example

holding status: a status equal to or more than contact and less than hold

sight status: a periphery monitoring status

### (3) Third Example

holding status: a status equal to or more than contact and less than hold

sight status: not a periphery monitoring status

### (4) Fourth Example

holding status: a status less than contact

sight status: not a periphery monitoring status

Subsequent to Step S14, determination is made whether or not the driver condition is satisfied (Step S16). The processing of Step S16 is executed based on comparison of the actual level DL and the requested level RL. Specifically, comparison of the acquisition statuses of the actual level DL and the requested level RL, and comparison of the sight statuses of the actual level DL and the requested level RL are performed individually.

First, a case where the actual level DL is set as in the above-described (1) first example is considered. The actual level DL (a status equal to or more than hold) of the holding status coincides with the level of “Hands-on” (a status equal to or more than hold). The actual level DL (periphery monitoring status) of the sight status coincides with the level of “Eyes-on”. Thus, even though any level of the above-described examples (1.1) to (2.2) is set as the requested level RL, the driver condition is satisfied.

Next, a case where the actual level DL is set as in the above-described (2) second example is considered. The actual level DL (periphery monitoring status) of the sight status is the same as that in First Example described above. The actual level DL (a status equal to or more than contact and less than hold) of the holding status is lower than the level of “Hands-on” (a status equal to or more than hold). Thus, the driver condition is satisfied unless the requested level of the holding status is set to the level of “Hands-on” (a status equal to or more than hold). In other words, in a case where the third level RL₃ in the above-described example (2.1) or (2.2) is set as the requested level RL, the driver condition is not satisfied.

Next, a case where the actual level DL is set as in the above-described example (3) is considered. The actual level DL (a status equal to or more than contact and less than hold) of the holding status is the same as that in the above-described second example. The actual level DL (not a periphery monitoring status) of the sight status coincides with the level of “Eyes-off”. That is, in comparison in terms of the level of involvement of the driver in the driving of the vehicle, the actual level of the sight status is lower than the level of “Eyes-on”. Thus, the driver condition is satisfied unless the requested level of the holding status is set to the level of “Hands-on” (a status equal to or more than hold), and the requested level of the sight status is set to the level of “Eyes-off”. Note that such a case is limited to a case where the first level RL₁ in the above-described example (1.1) or (2.1) is set as the requested level RL.

Next, a case where the actual level DL is set in the above-described example (4) is considered. The actual level DL (a status less than contact) of the holding status coincides with the level of “Hands-off”. That is, in comparison in terms of the level of involvement of the driver in the driving of the vehicle, the actual level of the holding status is lower than the level of “Hands-on”. The actual level DL (a status equal to or more than contact and less than hold) of the holding status is the same as that in the above-described third example. Thus, the driver condition is satisfied solely in a case where the first level RL₁ in the above-described example (1.1) or (2.1) is set as the requested level RL.

The above description is a processing example of Step S16. In a case where a determination result of Step S16 is negative, the execution of the autonomous driving control is prohibited (Step S12). Otherwise, the execution of the autonomous driving control is permitted (Step S18). “The execution of the autonomous driving control is permitted” means that processing for starting the execution of the autonomous driving control or processing for continuing the autonomous driving control in execution is executed.

1.4 Alert Control Processing

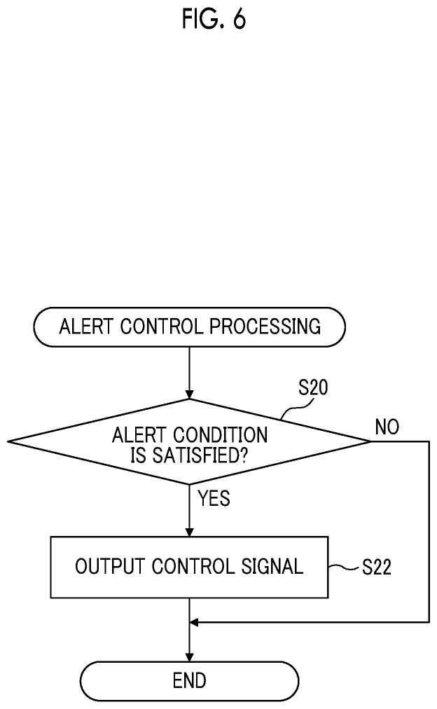

FIG. 6 is a flowchart illustrating a flow of processing of the alert control that is executed by the alert controller 53. In FIG. 6, the alert condition corresponding to the vehicle condition or the driver condition is focused. A processing routine shown in FIG. 6 is repeatedly executed during traveling of the vehicle.

In the processing routine shown in FIG. 6, first, determination is made whether or not the alert condition is satisfied (Step S20). The processing of Step S20 is executed by applying the statuses of the vehicle and the driver included in the recognition information from the status recognition unit 51 to the above-described conditions C1 to C3. In a case where a determination result of Step S20 is negative, the processing of the alert control ends.

In a case where the determination result of Step S20 is affirmative, a control signal is output to the HMI unit 30 (Step S22). For example, in a case where the above-described condition C1 is satisfied, a control signal for an alert, such as “Please close the door” or “Please close the window”, is output. In a case where the above-described condition C2 is satisfied, a control signal for an alert, such as “An abnormality occurs in the sensor” or “Please repair the sensor”, is output.

In a case where the above-described condition C3 is satisfied, a control signal for an alert according to the content of the actual level DL lower than the requested level RL is output. For example, in a case where the actual level DL of the holding status is lower than the requested level RL, a control signal for an alert, such as “Please hold the steering wheel” or “Please don't take the hands from the steering wheel”, is output. In a case where the actual level DL of the sight status is lower than the requested level RL, a control signal for an alert, such as “Please monitor the periphery of the vehicle”, is output.

1.5 Effects

According to Embodiment 1 described above, as final determination processing about whether or not to execute the autonomous driving control, the determination processing about whether or not the driver condition is satisfied is executed. In the final determination processing, the requested level RL is used as a determination threshold value. Then, the determination threshold value is set to a relatively lower level in a case where the vehicle speed V is in a relatively low range than in a case where the vehicle speed V is in a relatively high range.

In a case where the vehicle is traveling at a low speed, it is easier to secure traveling safety during the execution of the autonomous driving control than in a case where the vehicle is traveling at a high speed. Accordingly, in a case where the requested level RL is used as the determination threshold value, it is possible to expect the following effects. That is, it is possible to expand convenience in a case where the vehicle speed V is in the relatively low range, and to reliably secure traveling safety in a case where the vehicle speed V is in the relatively high range. From the above, it is possible to achieve both of expansion of convenience and securing of traveling safety during the execution of the autonomous driving control.

According to Embodiment 1, in a case where the alert condition set corresponding to the driver condition is satisfied, it is possible to execute the alert control. The alert condition is satisfied in a case where the actual level DL is lower than the requested level RL. That is, in a case where the driver condition is not satisfied, the alert condition is satisfied. Accordingly, in a case where solely the driver condition among the execution conditions is not satisfied, it is possible to prompt the driver to involve in the driving of the vehicle. Therefore, it is possible to increase an opportunity for the execution of the autonomous driving control. Furthermore, it is possible to avoid interruption of the autonomous driving control in execution.

### 2. Embodiment 2

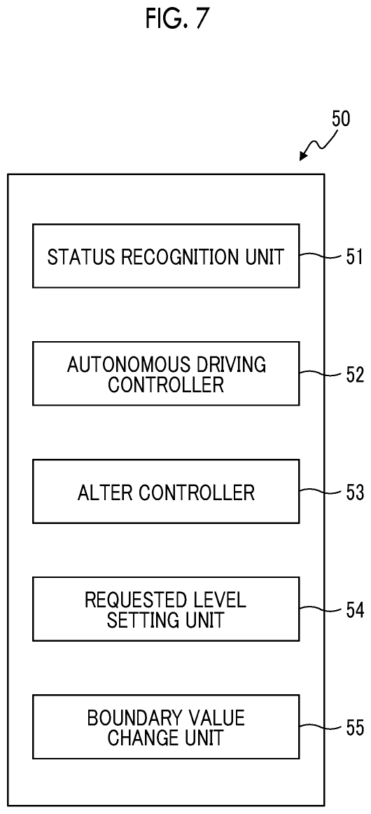

Next, Embodiment 2 will be described referring to FIGS. 7 and 12. Description of the configurations common to the configurations of Embodiment 1 described above will not be repeated.

2.1 Configuration of Control Device

FIG. 7 is a block diagram showing a configuration example of functions related to the autonomous driving control of the control device 50. As shown in FIG. 7, the control device 50 includes the status recognition unit 51, the autonomous driving controller 52, the alert controller 53, the requested level setting unit 54, and a boundary value change unit 55. The functional blocks are implemented by the processor of the control device 50 executing various control programs stored in the memory.

The boundary value change unit 55 changes the boundary value V_{TH} of the divided ranges of the vehicle speed V based on the recognition information from the status recognition unit 51. In a case where the requested level RL is set in two stages (that is, in a case of the setting example of FIG. 3), a target to be changed is the above-described boundary value V_{TH1}. In a case where the requested level RL is set in three stages (that is, in a case of the setting example of FIG. 4), a target to be changed is the above-described boundary values V_{TH1}, V_{TH2}. Hereinafter, several change examples will be described with the boundary value V_{TH1} as a representative.

### (1) First Change Example

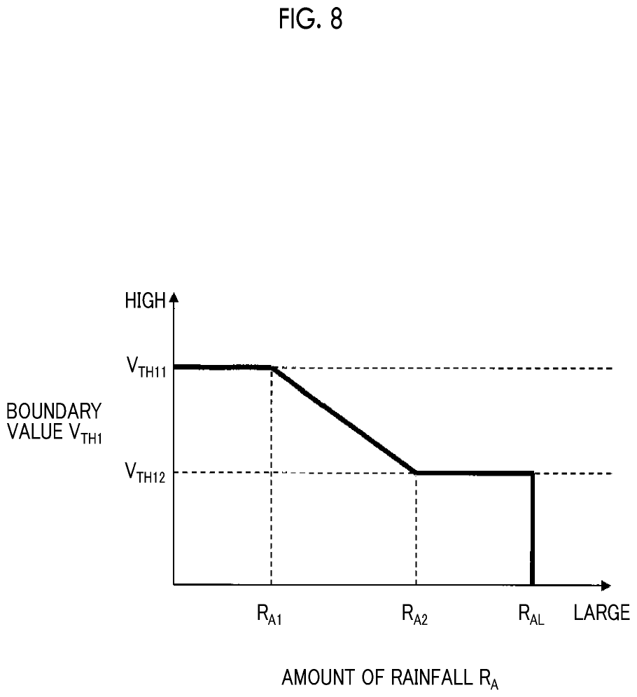

FIG. 8 is a diagram illustrating a first change example of the boundary value V_{TH1}. In the example of FIG. 8, the boundary value V_{TH1} is changed according to an amount of rainfall R_{A}. Information regarding the amount of rainfall R_{A} is not included in the above-described “needed information”, and is included in the environment information around the vehicle. The amount of rainfall R_{A} is acquired by the status recognition unit 51 recognizing detection information of a rain sensor (not shown).

In the example of FIG. 8, a first boundary value V_{TH11} corresponds to a reference value. In a case where the amount of rainfall R_{A} is less than a first amount of rainfall R_{A1}, the boundary value V_{TH1} is set to the first boundary value V_{TH11}. In a case where the amount of rainfall R_{A} is in a range of the first amount of rainfall R_{A1} to a second amount of rainfall R_{A2}, the boundary value V_{TH1} is changed. Specifically, the boundary value V_{TH1} decreases from the first boundary value V_{TH11} to a second boundary value V_{TH12} as the amount of rainfall R_{A} becomes large. In a case where the amount of rainfall R_{A} is in a range of the second amount of rainfall R_{A2} to an upper limit amount of rainfall R_{AL}, the boundary value V_{TH1} is changed to the second boundary value V_{TH12}.

In a case where the amount of rainfall R_{A} is large, traveling safety is more hardly secured than in a case where the amount of rainfall R_{A} is small. In view of this point, in a case where the boundary value V_{TH1} decreases as the amount of rainfall R_{A} becomes large, the driver condition is hardly satisfied as the rain gets heavy. That is, the execution of the autonomous driving control is hardly permitted as the rain gets heavy.

In the example of FIG. 8, a wiping speed of a wiper may be used instead of the amount of rainfall R_{A}. The wiping speed is calculated based on the detection information of the rain sensor. The wiping speed may be calculated based on the detection information of the rain sensor and the vehicle speed detection device 20.

### (2) Second Change Example

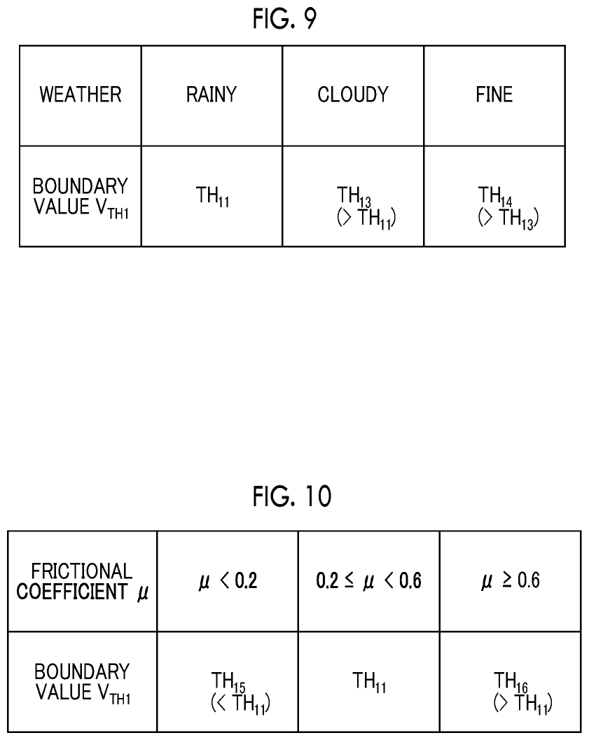

FIG. 9 is a diagram illustrating a second change example of the boundary value V_{TH1}. In the example of FIG. 9, the boundary value V_{TH1} is changed according to the weather. Information regarding the weather is not included in the above-described “needed information”, and is included in the environment information around the vehicle. Information regarding the weather is acquired by the status recognition unit 51 recognizing the communication information.

In the example of FIG. 9, in a case where the weather is rainy, the boundary value V_{TH1} is set to the first boundary value V_{TH11} as a reference value. In a case where the weather is cloudy, the boundary value V_{TH1} is changed to a third boundary value V_{TH13} (>V_{TH11}). In a case where the weather is fine, the boundary value V_{TH1} is changed to a fourth boundary value V_{TH14} (V_{TH13}).

In a case where the weather is rainy, traveling safety is more hardly secured than in a case where the weather is cloudy. In a case where the weather is cloudy, traveling safety is more hardly secure than in a case where the weather is fine. In view of this point, in a case where the boundary value V_{TH1} decreases as the weather is bad, the driver condition is hardly satisfied as the weather is bad. That is, the execution of the autonomous driving control is hardly permitted as the weather is bad.

### (3) Third Change Example

FIG. 10 is a diagram illustrating a third change example of the boundary value V_{TH1}. In the example of FIG. 10, the boundary value V_{TH1} is changed according to a frictional coefficient μ of a road surface on which the vehicle is traveling. Information regarding the frictional coefficient μ is not included in the above-described “needed information”, and is included in the environment information around the vehicle. Information regarding the frictional coefficient μ is acquired by the status recognition unit 51 recognizing the detection information of the rain sensor or the communication information.

In the example of FIG. 10, in a case where 0.2<μ<0.6, the boundary value V_{TH1} is set to the first boundary value V_{TH11} as a reference value. In a case where μ<0.2, the boundary value V_{TH1} is changed to a fifth boundary value V_{TH15} (<V_{TH11}). In a case where μ≥0.6, the boundary value V_{TH1} is changed to a sixth boundary value V_{TH16} (>V_{TH11}).

In a case where the frictional coefficient μ is relatively small, traveling safety is more hardly secured than in a case where the frictional coefficient μ is relatively large. In view of this point, in a case where the boundary value V_{TH1} decreases as the frictional coefficient μ becomes small, the driver condition is hardly satisfied as the road surface is slippery. That is, the execution of the autonomous driving control is hardly permitted as the road surface is slippery.

### (4) Fourth Change Example

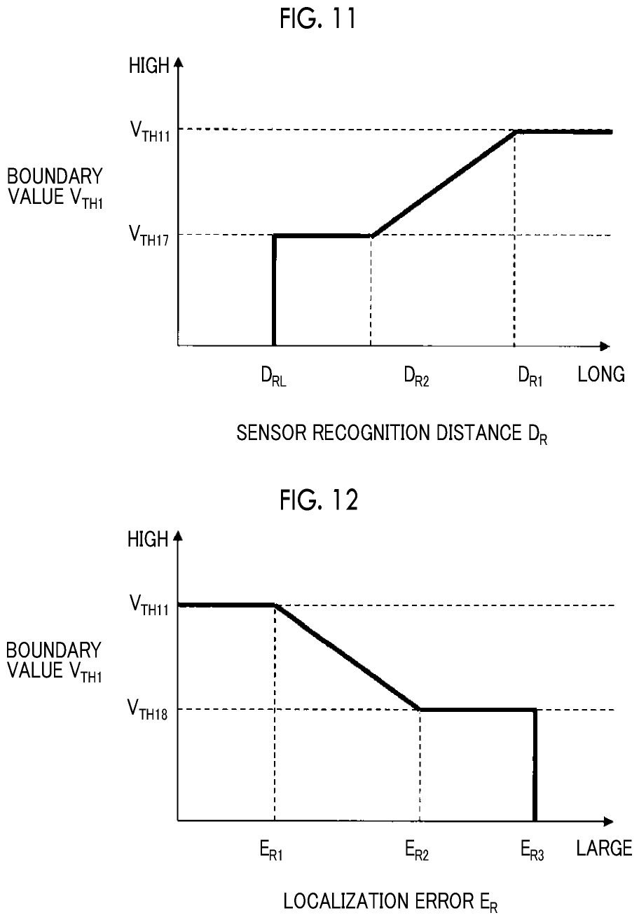

FIG. 11 is a diagram illustrating a fourth change example of the boundary value V_{TH1}. In the example of FIG. 11, the boundary value V_{TH1} is changed according to a sensor recognition distance D_{R}. The “sensor recognition distance D_{R}” is defined as an upper limit value (longest distance) of a distance at which an external sensor is able to recognize an object around the vehicle. In a case where the external sensor recognizes a stationary object registered in the map database, the recognizable distance is obtained as the distance between the stationary object and the vehicle. The sensor recognition distance D_{R} may be calculated focusing on a specified external sensor or may be calculated as a representative value (for example, a median value and an average value) of at least two external sensors. Information regarding the sensor recognition distance D_{R} is not included in the above-described “needed information”, and is included in information (hereinafter, referred to as “recognition status information”) indicating the recognition status of the external sensor.

In the example of FIG. 11, in a case where the sensor recognition distance D_{R} is longer than a first distance D_{R1}, the boundary value V_{TH1} is set to the first boundary value V_{TH11} as a reference value. In a case where the sensor recognition distance D_{R} is in a range of the first distance D_{R1} to a second distance D_{R2}, the boundary value V_{TH1} is changed. Specifically, the boundary value V_{TH1} decreases from the first boundary value V_{TH11} to a seventh boundary value V_{TH17} as the sensor recognition distance D_{R} becomes short. In a case where the sensor recognition distance D_{R} is in a range of the second distance D_{R2} to a lower limit distance D_{RL}, the boundary value V_{TH1} is changed to the seventh boundary value V_{TH17}.

In a case where the sensor recognition distance D_{R} is relatively short, traveling safety is hardly secured than in a case where the sensor recognition distance D_{R} is relatively long. In view of this point, in a case where boundary value Van decreases as the sensor recognition distance D_{R} becomes short, the driver condition is hardly satisfied as an absolute recognition status of the external sensor is poor. That is, the execution of the autonomous driving control is hardly permitted as the absolute recognition status is poor.

### (5) Fifth Change Example

FIG. 12 is a diagram illustrating a fifth change example of the boundary value V_{TH1}. In the example of FIG. 12, the boundary value V_{TH1} is changed according to a localization error E_{R}. The “localization error E_{R}” is defined as an error between a feature (for example, three-dimensional position and direction) of an object recognized by the external sensor and a feature of the object included in the map information. The localization error E_{R} is calculated in the middle of processing (that is, localization processing) for estimating a detailed position of the vehicle on a map. In the localization processing, a position and direction of the vehicle in which the localization error E_{R} is minimized are estimated as a current position and direction of the vehicle. Information regarding the localization error E_{R} is not included in the above-described “needed information, and is included in the recognition status information.

In the example of FIG. 12, in a case where the localization error E_{R} is smaller than a first error E_{R1}, the boundary value Van is set to the first boundary value V_{TH11} as a reference value. In a case where the localization error E_{R} is in a range of the first error E_{R1} to a second error E_{R2}, the boundary value V_{TH1} is changed. Specifically, the boundary value Van decreases from the first boundary value V_{TH11} to an eighth boundary value V_{TH18} as the localization error E_{R} becomes large. In a case where the localization error E_{R} is in a range of the second error E_{R2} to a third error E_{R3}, the boundary value V_{TH1} is changed to an eighth boundary value V_{TH18}.

The localization error E_{R} is large means that the degree of coincidence between the feature of the recognized object and the feature of the object included in the map information is low. In a case where the degree of coincidence is low, since accuracy of estimation through the localization processing is degraded, traveling safety is hardly secured. In this way, in a case where the localization error E_{R} is relatively large, traveling safety is hardly secured than in a case where the localization error E_{R} is relatively small. In view of this point, in a case where the boundary value V_{TH1} decreases as the localization error E_{R} becomes large, the driver condition is hardly satisfied as a relative recognition status is poor. That is, the execution of the autonomous driving control is hardly permitted as the relative recognition status is poor.

2.2 Effects

According to Embodiment 2 described above, the boundary value V_{TH1} is changed based on the environment information or the recognition status information. A direction of change of the boundary value Van goes toward a low speed side as traveling safety is hardly secured, and goes toward a high speed side as traveling safety is easily secured. Accordingly, it is possible to execute the determination processing about whether or not the driver condition is satisfied using the determination threshold value (that is, the requested level RL) set in consideration of the information.

What is claimed is:

1. A vehicle control system comprising:
a status detection device configured to detect a status of a driver of a vehicle;
a vehicle speed detection device configured to detect a traveling speed of the vehicle; and
a control device configured to execute autonomous driving control of the vehicle, wherein:
the control device is configured to acquire an actual level indicating an actual level of involvement of the driver in driving of the vehicle based on the status of the driver, set a requested level indicating a level of involvement in the driving of the vehicle requested to the driver by the control device based on the traveling speed, and prohibit the execution of the autonomous driving control in a case where the requested level is equal to or higher than the actual level,
the requested level is set in each of at least two divided vehicle speed ranges, and
the requested level set in a relatively low vehicle speed range is lower than the requested level set in a relatively high vehicle speed range.

2. The vehicle control system according to claim 1, further comprising an information providing device configured to provide information to the driver,
wherein the control device is further configured to output a control signal for prompting to involve in the driving of the vehicle to the information providing device in a case where the requested level is equal to or higher than the actual level.

3. The vehicle control system according to claim 1, wherein the control device is further configured to acquire environment information around the vehicle or recognition status information of a recognition system sensor of the vehicle, and change boundary values of the at least two divided vehicle speed ranges based on the environment information or the recognition status information.

4. The vehicle control system according to claim 3, wherein:
the environment information is information regarding an amount of rainfall around the vehicle; and
the control device is configured to decrease the boundary values in a case where the amount of rainfall is large than in a case where the amount of rainfall is small.

5. The vehicle control system according to claim 3, wherein:
the environment information is information regarding weather around the vehicle; and
the control device is configured to decrease the boundary values in a case where the weather is cloudy than in a case where the weather is fine, and decrease the boundary values in a case where the weather is rainy than in a case where the weather is cloudy.

6. The vehicle control system according to claim 3, wherein:
the environment information is information regarding a frictional coefficient of a road surface on which the vehicle travels; and
the control device is configured to decrease the boundary values in a case where the frictional coefficient is small than in a case where the frictional coefficient is large.

7. The vehicle control system according to claim 3, wherein:
the recognition status information is an upper limit value of a distance at which the recognition system sensor is able to recognize an object around the vehicle; and
the control device is configured to decrease the boundary values in a case where the upper limit value is small than in a case where the upper limit value is large.

8. The vehicle control system according to claim 3, further comprising a map database storing map information, wherein:
the recognition status information is an error between a feature of an object around the vehicle recognized by the recognition system sensor and a feature of the object included in the map information; and
the control device is configured to decrease the boundary values in a case where the error is large than in a case where the error is small.
